(19) United States
(12) Patent Application Publication
(10) Pub. No.: US 2003/0164779 A1
(43) Pub. Date: Sep. 4, 2003

(54) Method for transmitting location-related information between a control centre and a mobile terminal, a mobile terminal and a control centre

(76) Inventors: Arnold Gieseke, Giesen (DE); Martin Hans, Hildesheim (DE); Gunnar Schmidt, Wolfenbuettel (DE); Dieter Thoms, Hildesheim (DE); Frieder Mundt, Neumuenster (DE)

Correspondence Address: KENYON & KENYON, ONE BROADWAY, NEW YORK, NY, 10004, US

(21) Appl. No.: 10/220,116

(22) PCT Filed: Feb. 16, 2001
(86) PCT No.: PCT/DE01/00593

(30) Foreign Application Priority Data
Mar. 3, 2000 (DE) 100 10 436.3

(51) Int. Cl. G08G 1/123

(52) U.S. Cl. 340/993; 701/201

(57) ABSTRACT

A method for transmitting location-related data information between a main station (1) and a mobile terminal (5), a main station (1) and a mobile terminal (5) are proposed, which make possible the position tracing of the mobile terminal (5) or a navigational application on the display device of the mobile terminal (5). As to mobile terminal (5), this may be particularly a mobile telecommunications terminal. In a first step, a position of a mobile terminal (5) is ascertained and transmitted to the main station (1). In a second step, location-related data information for the mobile terminal (5) is formed in the main station (1), in dependence upon the ascertained position of the mobile terminal (5). In a third step, the location-related data information is transmitted from the main station (1) to the mobile terminal (5). In a fourth step, the location-related data information received is brought to reproduction on a reproduction device (10) of the mobile terminal (5).

### BACKGROUND INFORMATION

The present invention relates to a method for transmission of location-related data between a main station and a mobile terminal, by a mobile terminal and by a main station according to the species defined in the independent claims.

Methods are known for transmitting location-related data between a main station and a mobile terminal, and are used, for example, in locating mobile radio devices in a cellular mobile radio network.

With the aid of GPS (Global Positioning System) technology, determining a location is possible to an accuracy of 10 m. This system is used, for instance, in determining the location of ships and motor vehicles, such as with the “Travel Pilot” of Blaupunkt. In this respect, location information is always entered into local existing map material which is present on a data carrier, such as a compact disk, and is presented visually to the user. The location information is used, for instance, for calculating the route and for guiding the user to a desired destination.

The H.32x methods standardized by the ITU-T (International Telecommunication Union) are used for transmitting audio, video and data information over fixed and mobile networks. In this connection, the main field of use is videotelephony between two or more terminals. In the most recent period, these standards are increasingly being used for transmitting multimedia information such as live-camera pictures or for TV transmission, such as via the TV Infoserver of German Telekom.

Currently obtainable mobile telephones, such as the Nokia mobile telephone and PDA's (Personal Digital Assistant), such as the Apple Message Pad have sufficiently large displays to show map material. On account of the limited memory being offered in the named terminals, mobile telephones are currently being used only as voice terminals, as interface for access to the Internet and for sending text messages, for example, e-mail on the Internet or short messages according to the SMS Standard (Short Message Service).

### SUMMARY OF THE INVENTION

As compared to that, the method according to the present invention for transmitting location-related data information, the mobile terminal according to the present invention and the main station according to the present information, having the features of the independent claims, have the advantage that, in a first step, a position of a mobile terminal is ascertained and transmitted to the main station, that, in a second step, location-related data information for the mobile terminal is formed in the main station in dependence upon the ascertained position of the mobile terminal, that, in a third step, the location-related data information is transmitted from the main station to the mobile terminal, and that, in a fourth step, the location-related data information is brought to reproduction on a reproduction device of the mobile terminal. In this manner, the location-related data information, such as, for instance, the determination of the location of the mobile terminal may be implemented, with the aid of a geographical map or a route recommendation for a navigational application, independently of the memory space and computing capacity available in the mobile terminal, so that the functionality and the usefulness of the mobile terminal are substantially increased, especially if designed as a mobile telephone or PDA.

By the measures described in the dependent claims, advantageous further developments and improvements of the method for transmitting location-related messages, the mobile terminal and the main station according to the independent claims are possible.

It is of particular advantage that, in the second step, a section of a geographical map is selected in the main station which includes the ascertained position of the mobile terminal, that, in a third step, the selected map section is transmitted from the main station to the mobile terminal and that, in a fourth step, the transmitted map section having the ascertained position is brought to reproduction on a reproduction device.

In this way, the map material may be centrally retained in the main station, for instance, in a navigation server, and can there be rapidly and simply updated, an updating carried out in the main station being useful to many users of corresponding mobile terminals. On account of the central storage, storage space in the terminals is saved, and multiple storage of map material is prevented.

It is particularly advantageous that a destination is entered in the mobile terminal and transmitted to the main station, that a route proposal between the ascertained position of the mobile terminal and the destination input is computed in the main station, that the route proposal is transmitted by the main station to the mobile terminal as additional information, and that the route proposal is reproduced on the reproduction device of the mobile terminal. In this way, the terminal may be used for navigation and route guidance, which enhances its functionality. In this context, if the mobile terminal is designed as a mobile telephone or as a PDA, it becomes a navigational device which may also be used by pedestrians and bicyclists.

A further advantage is that the selected map section is transmitted to the mobile terminal in coded form, by a compression method, particularly by using one of image compression methods H.261 and H.263 according to ITU-T Standard H.32x (International Telecommunication Union). In this manner, bandwidth may be saved in the transmission of the map section from the main station to the mobile terminal, so that the transmission of the map material from the main station to the mobile terminal is implementable even with limited bandwidth of a mobile radio network used as transmission medium.

A further advantage is that, in a fifth step, a new position of the mobile terminal is ascertained and transmitted to the main station, that, in a sixth step, a new map section is selected in the main station, which includes the new position of the mobile terminal, that, in a seventh step, image data are transmitted from the main station to the mobile terminal, in dependence upon the differences between the selected new map section and the present map section, and that, in an eighth step, the present map section is brought updated to reproduction on the reproduction device of the mobile terminal, in dependence upon the transmitted image data. When done in this way, it is not necessary, when updating the map section brought to reproduction on the reproduction device of the mobile terminal, each time to transmit a completely new map section from the main station to the mobile terminal, but only the changes between the image data shown in the present map section and the new map section. Especially when the new map section includes a part of the present map section, this method leads to a transmission, requiring little bandwidth, of the image data required for updating the present map section. Such an updating may then be also performed particularly fast.

Such a bandwidth-saving method for the transmission of image data, from the main station to the mobile terminal, which data are then used for updating the map section reproduced on the reproduction device of the mobile terminal, may be implemented in that, at the selection of the new map section in the sixth step, especially when using one of image compression methods H.261 and H.263, the present map section is divided up into individual image blocks, that for each of the image blocks, a movement vector is calculated in dependence upon the position change from the previous position to the new position of the mobile terminal, that the new map section is estimated starting from the present map section and the movement vectors, that the estimated map section is compared to the new map section by difference formation, so that a difference image is created, that, using the image data in the seventh step, the difference image is transmitted to the mobile terminal, that, in a seventh step, the movement vectors are also transmitted from the main station to the mobile terminal, and that, in the eighth step, the map section to be reproduced on the reproduction device is computed from the present map section, in that the present map section is shifted block-wise with the aid of the movement vectors, and the shifted map section formed in this way is overlaid with the difference image. In this context, the transmission of the difference image and of the movement vectors requires less bandwidth and is more rapid than the transmission of the complete new map section from the main station to the mobile terminal. It is also the case that, for transmitting image data, a method already used in videotelephony can be used, for instance, the standardized H.32x method, so that the application range of such a method becomes greater, and no new method is necessary for the transmission of map materials.

A further advantage is that, at predefined times in the seventh step, the new map section is transmitted from the main station to the mobile terminal with the aid of the image data, and that, in the eighth step, the new map section is brought to reproduction on the reproduction device in the new position. In this manner it is possible, at regular intervals, to adjust the reproduction of the map material at the mobile terminal to the original map material, and thereby to limit an accumulation of transmission errors in the transmission of the difference image and of the movement vectors, which may lead to a corruption of the map material to be reproduced.

It is of special advantage that, during selection of the new map section in the sixth step, map regions are ascertained which are included only in the new map section and not in the present map section, that, in the seventh step, the ascertained map regions are transmitted from the main station to the mobile terminal with the aid of the image data, and that, in the eighth step, the map section to be reproduced on the reproduction device is calculated from the presently reproduced map section in that the present reproduced map section is shifted on account of the overall movement vector computed from the position change of the previous position to the new position of the mobile terminal, and the shifted map section formed in this manner is supplemented by the transmitted map sections. In this way, bandwidth is also saved in the transmission of the image data from the main station to the mobile terminal, required for updating the map section reproduced currently on the reproduction device, since only the changing map regions have to be transmitted from the main station to the mobile terminal. Map regions which are included in both the present and the new map sections do not have to be transmitted. Therefore, the transmission of the image data required for updating the map sections reproduced on the reproduction device may also take place particularly rapidly, and it becomes more rapid the less the new map region deviates from the present map section, since then so many fewer supplementing map regions have to be transmitted from the main station to the mobile terminal. By the transmission of original map regions from the main station to the mobile terminal one may avoid accumulation of transmission errors as may occur, for example during successive transmission of difference images. Regular transmission of a complete new map section for limiting such accumulating errors is therefore not necessary. Furthermore, no computation of a difference image and no estimation of the new map section in the main station are required, so that, compared to the previously described method, computing effort and computing time can be saved in the main station. The updating of the map section to be reproduced on the reproduction device of the mobile terminal can therefore take place that much more quickly.

The image data to be transmitted for the updating of the map sections to be reproduced on the reproduction device of the mobile terminal can also be transmitted in an advantageous manner by a compression method, particularly using one of the image compression methods H.261 and H.263 according to ITU-T Standard H.32x, while saving bandwidth and transmission time.

A further advantage is that, in the first step, information about the size of the map section that can be shown on the display device is transmitted from the mobile terminal to the main station. In this way, the size of the map section transmitted from the main station to the mobile terminal, the size of the difference image or the size of the supplementary map regions to be transmitted for updating the map section to be reproduced may already be adapted in the main station to the size of the map section to be reproduced on the reproduction device. This prevents the transmission of too many image data, and therefore excessive demand for bandwidth and transmission time.

Yet another advantage is that the position of the mobile terminal is input on an input device of the mobile terminal. In this way, the user of the mobile terminal may input any position whatever, and thereby request return from the main station of any map sections whatsoever.

### BRIEF DESCRIPTION OF THE DRAWINGS

Exemplary embodiments of the invention are shown in the drawings and are explained in greater detail in the following description. The Figures show:

FIG. 1 a block diagram of a main station according to the present invention and a mobile terminal for carrying out a method according to the present invention for transmitting location-related data information,

FIG. 2 a flow diagram for describing the general flow of the method according to the present invention,

FIG. 3 a flow diagram for describing a part of the general flow as in a first specific embodiment and

FIG. 4 a flow diagram for describing a part of the general flow as in a second specific embodiment.

### DESCRIPTION OF THE EXEMPLARY EMBODIMENTS

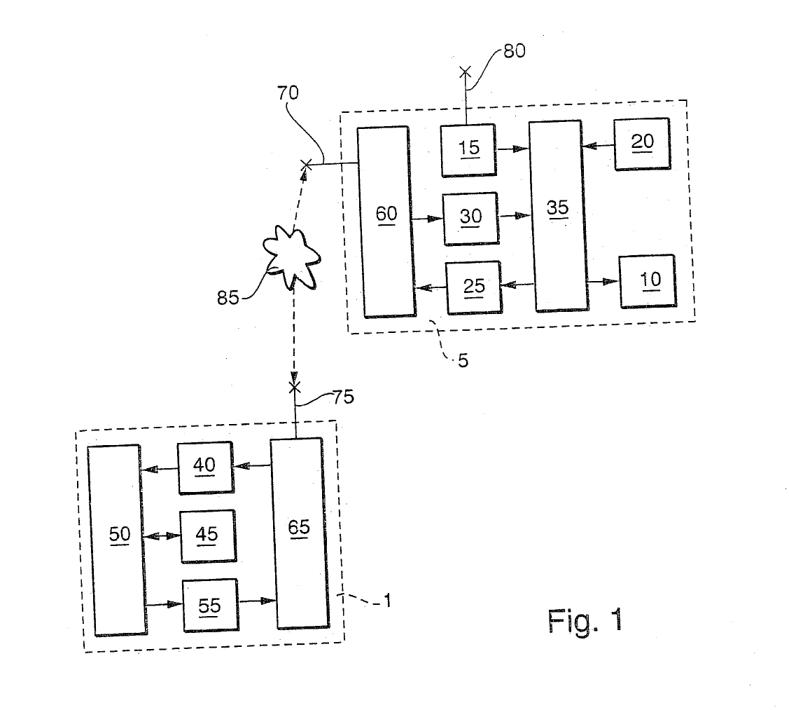

In FIG. 1, 5 denotes a mobile terminal which may, for instance, be developed as a mobile phone or as a PDA (Personal Digital Assistant). Mobile terminal 5 includes a first send/receive antenna 70 connected to a first antenna unit 60. First send/receive antenna 70 is here used for sending and receiving data over a mobile radio network 85. First antenna unit 60, in the receiving direction, is connected to a first evaluation unit 35 via a first receiving unit 30. First evaluation unit 35, in the sending direction, is connected to first antenna unit 60 via a first transmitting unit 25. A position-finding receiver 15 is also connected to evaluation unit 35, and may be designed, for example, as a GPS receiver (Global Positioning System), and to which a receiving antenna 80 is connected to receive location-finding data. This receiving antenna 80 for location-finding data may, for instance, designed as a GPS patch antenna. In this example, an input device 20 and a reproduction device 10 are also connected to first evaluation unit 35. Reproduction device 10 here includes a display device, for instance, in the form of a liquid crystal display, and, in addition, may optionally include one or more loudspeakers for acoustical reproduction.

Mobile terminal 5 exchanges location-related data information, via mobile radio network 85, with a main station 1, which includes a second send/receive antenna 75 connected to a second antenna unit 65. In this context, second antenna unit 65 is connected to a second evaluation unit 50 in the receiving path, via a second receiving unit 40. Second evaluation unit 50 is connected in the sending path to second antenna unit 65, via a second transmitting unit 50. Main station 1 also includes a memory 45, which is connected to second evaluation unit 50.

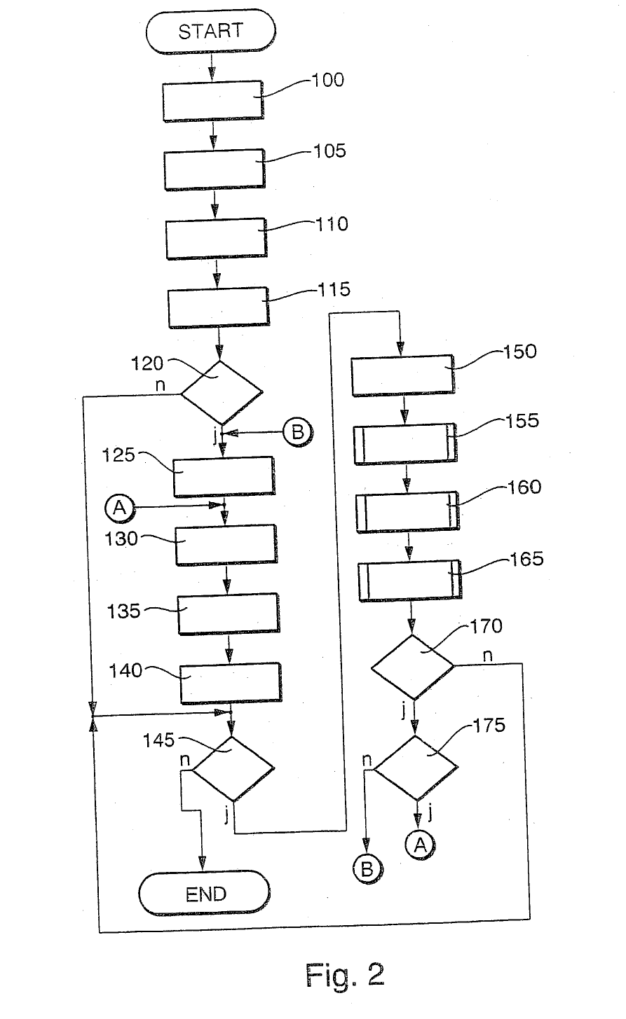

The method according to the invention will now be explained in greater detail, using the flow diagram in FIG. 2. At a program point 100, first evaluation unit 35 ascertains a position of mobile terminal 5. The ascertainment of the position can be made, for example, in two different ways. According to a first way, the position of mobile terminal 5 is ascertained by receiving location-finding data via receiving antenna 80 for location-finding data and by location-finding receiver 15 in first evaluation unit 35. According to a second way, it may optionally be provided that the user of mobile terminal 5 inputs any particular position on input device 20, in order to have a look at any particular map section. Subsequently, first evaluation unit 35 causes first transmitting unit 25 to broadcast the position of mobile terminal 5 ascertained in one of the ways mentioned, with the aid of a corresponding location data signal from first send/receive antenna 70 via mobile radio network 85 to main station 1. In this connection, the location data signal may be developed as a text message or a short message, which is transmitted, for instance, in a GSM mobile radio network (Global System for Mobile Communications) as an SMS message (Short Message Service). Using the text message or the short message, a calling number of mobile terminal 5 may also be transmitted to main office 1, so as to make possible a return call from main station 1 for sending map data and/or route suggestions to mobile terminal 5. In main station 1 this location signal having information about the position of mobile terminal 5 is received by second send/receive antenna 75, and passed onto second evaluation unit 50 via second receiving unit 40. Subsequently, the program branches to a program point 105.

At program point 105, second evaluation unit 50 ascertains a section of a geographic map filed in memory 45, this section including the ascertained position of mobile terminal 5. The size of the selected section may here be adapted to the size of the display device of mobile terminal 5. For this, however, main station 1 must know the size of the display device of mobile terminal 5. Corresponding data concerning the size of the display unit of mobile terminal 5 may in this case be transmitted ahead of time or transmitted together with the first ascertained position of mobile terminal 5 to main station 1 at program point 100. Second evaluation unit 50 can additionally select the map section in such a way that the ascertained position of mobile terminal 5 lies in the middle or in an average range of the selected map section. Of course, it may also be provided that second evaluation unit 50 selects the map section in such a way that the ascertained position of mobile terminal 5 lies in an edge region of the selected map section. This can make sense with respect to a navigational application if as much as possible of the map material in the direction of planned movement of mobile terminal 5 is to be shown on the display device, but as little as possible of the map material in the region of the path already traveled by mobile terminal 5.

In addition, second evaluation unit 50 fades the ascertained position of mobile terminal 5 into the selected map section, at the appropriate location.

After program point 105 the program branches to a program point 110. At program point 110, second evaluation unit 50 causes second transmitting unit 55, for example, with the aid of a callback because of the received call number of mobile terminal 5, to transmit the selected map section having the faded-in position of mobile terminal 5, with the aid of a suitable image signal, from second send/receive antenna 75 to mobile terminal 5 via mobile radio network 85. This image signal is then received by first send/receive antenna 70 and fed via first receiving unit 30 to first evaluation unit 35. Subsequently, the program branches to a program point 115.

At program point 115, first evaluation unit 35 causes a display of the received map section having the faded-in position of mobile terminal 5 on the display device of reproduction device 10. For the transmission of the selected map section from main station 1 to mobile terminal 5, second evaluation unit 50 may cause a coding of the selected map section by a compression method, in order to save bandwidth and time in transmitting the selected map section from main station 1 to mobile terminal 5. In this connection, transmission of the selected map section may take place, for example, according to the ITU-T Standard H.32x (International Telecommunication Union), it being possible to use one of image compression methods H.261 and H.263 as the method of compression.

At program point 120, first evaluation unit 35 tests whether the user of mobile terminal 5 has input a navigational instruction at input 20. If this is the case, the program branches to a program point 125, otherwise it branches to a program point 145.

At program point 125, first evaluation unit 35 prompts the user, optically or acoustically, via reproduction device 10 to input a destination. After input of the destination on input device 20, first evaluation device 35 causes first transmitting unit 25 to transmit this destination, with the aid of a suitable location data signal, from first send/receive antenna 70 to main station 1 via mobile radio network 85. This location data information is then received via second send/receive antenna 75 in main station 1, and passed on via second receiving unit 40 to second evaluation unit 50. Subsequently, the program branches to a program point 130.

At program point 130, second evaluation unit 50 computes a route proposal between the ascertained position of terminal 5 and the input destination. This route proposal may take into account up-to-date traffic data, such as traffic jams, blockages and changes in the traffic route network, or the like. Subsequently, the program branches to a program step 135.

At program step 135, second evaluation unit 50 causes second transmitting unit 55 to transmit the computed route proposal, with the aid of an appropriate navigational data signal, from second send/receive antenna 75 to mobile terminal 5 via mobile radio network 85. The navigational data signal may also be formed as a text message or a short message, and may, for example, be transmitted in a GSM mobile radio network as an SMS message. The transmission of the navigational data signal in voice form during a call of mobile terminal 5 by main station 1 is also possible. This navigational data signal is received by first send/receive antenna 70 and fed to first evaluation unit 35 via first transmitting unit 30. Subsequently, the program branches to a program point 140.

At program point 140, first evaluation unit 35 causes an optical and/or acoustical reproduction in reproduction device 10, of the route proposal computed in main station 1. An acoustical reproduction can be made, for instance, by voice reproduction. This makes the use of mobile terminal 5 in a vehicle easier. If the navigational data signal was transmitted as a text message or a short message, then a voice output of this text message or short message may be implemented in mobile terminal 5 with the aid of a language synthesis component not shown in FIG. 1. However, such a text message or short message, which includes the route proposal, can also be displayed on the display device. Subsequently, the program branches to a program point 145.

At program point 145, first evaluation unit 35 tests whether, within a specified time, a new position of mobile terminal 5 has become available, either via location receiver 15 or by user input on input device 20, which differs from the previous position of mobile terminal 5. If this is the case, the program branches to a program step 150, otherwise the program is exited.

At program step 150, first evaluation unit 35 causes first transmitting unit 25 to transmit the new position of mobile terminal 5 with the aid of an appropriate location data signal from first send/receive antenna 70 to main station 1 via mobile radio network 85. This location data signal, having the new position of mobile terminal 5, is received by second send/receive antenna 75, and is passed to second evaluation unit 50 via second receiving unit 40. Subsequently, the program branches to a program point 155.

At program point 155, second evaluation unit 50 selects a new map section from the map material filed in memory 45, which includes the new position of mobile terminal 5, this new map section in turn being able to be adapted in a corresponding manner to the size of the display device of mobile terminal 5. The new map section may, in this case, be selected by second evaluation unit 50 in such a way that the new position of mobile terminal 5 lies in the middle or in a middle region of the selected new map section. However, as described before, it can also be provided that the new position of mobile terminal 5 lies in an edge region of the selected new map section.

Subsequently, second evaluation unit 50 compares the present map section, selected before the new map section selected for mobile terminal 5, with the selected new map section and generates image data in dependence upon differences between the two map sections. Subsequently the program branches to a program point 160.

At program point 160, second evaluation unit 50 causes second transmitting unit 55 to transmit the generated image data from second send/receive antenna 75 to mobile terminal 5 via the mobile radio network 85. The generated image data are then received by first send/receive antenna 70 and passed on via first transmitting unit 30 to first evaluation unit 35.

In this connection, as described before, the image data may be transmitted to mobile terminal 5 from main station 1 to mobile terminal 5 coded by a compression method. The transmission of the image data from main station 1 to mobile terminal 5 may be carried out, in this context, as described, for example, according to an image telephony standard, for instance, according to the ITU-T Standard H.32x, one of image compression methods H.261 and H.263 being applicable.

After program point 160 the program branches to a program point 165. At program point 165, first evaluation unit 35 updates the map section displayed up to now on the display device of reproduction device 10 in dependence upon the transmitted image data, and brings the map section thus brought up to date to the display device for display.

Subsequently, the program branches to a program point 170. At program point 170, first evaluation unit 35 tests whether a navigational application was activated by the user of mobile terminal 5 on input device 20 or is still running. If this is the case, the program branches to a program point 175, and otherwise the program branches back to program point 145. At program point 175, first evaluation unit 35 tests whether a destination has already been input on input device 20 for the navigational application and has been transmitted to main station 1. If this is the case, then the program branches back to program point 130, and the route computation is correspondingly updated with the aid of the new position and the destination that is already known. Otherwise the program branches back to program point 125, and the input of an appropriate destination is requested as described.

In case mobile terminal 5 reaches the specified destination during a running navigational application, that is, that second evaluation unit 50 determines the identity of the position of mobile terminal 5 and the destination, the navigational application is broken off, after corresponding information concerning this breaking-off has been transmitted from main station 1 to mobile terminal 5, and has there been reproduced on reproduction device 10. For a straight navigational application without transmission of map sections from main station 1 to mobile terminal 5, it may also be provided that the flow diagram as in FIG. 2 first applies after program point 120, and is run through without program points 150, 155, 160, 165, so that the program branches from program point 145, in the “yes” decision case, directly to program point 170. This alternative specific embodiment makes sense, for instance, if mobile terminal 5 is connected to a computer, e.g. a laptop, via a data interface, navigational software having been stored in the computer memory using map material. A route proposal transmitted to mobile terminal 5 from main station 1 may then be passed on via the data interface to the connected computer. Using the navigational software, the computer then selects a map section from the map material which appertains to the route proposal, and brings the route proposal to display on a display device, for instance, a display of the computer together with the appropriate selected map section. In this way, mobile terminal 5 shares the use of the computer's display device, which can thus also be regarded as an external portion of reproduction device 10.

For the updating of the map section brought for display on the display device of reproduction device 10 at a time when the position of mobile terminal 5 changes, two different specific embodiments are given as examples in the following.

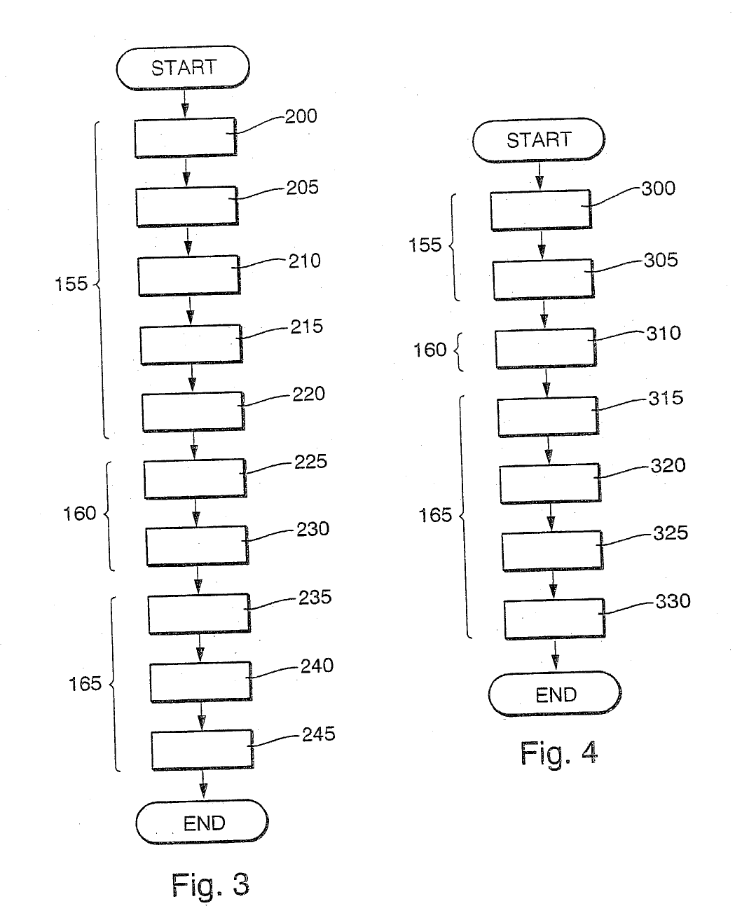

FIG. 3 shows a flow plan for the sequence as in the first of the two specific embodiments. In this context, this sequence relates to program points 155, 160 and 165 as in FIG. 2, which, in FIG. 2, are therefore shown each time as subroutines having double crosspieces. In this context, program point 155 is divided as follows for the first specific embodiment:

At a program point 200, second evaluation unit 50 ascertains from the map material stored in memory 45 the new map section for the new position of mobile terminal 5, as described. Subsequently, the program branches to a program point 205.

At program point 205, second evaluation unit 50 subdivides the present map section, selected before the new map section for mobile terminal 5 into image blocks. Subsequently, the program branches to a program point 210.

At program point 210, second evaluation unit 50 computes a movement vector from the previous position to the new position for each of the image blocks, in dependence upon the position change of mobile terminal 5. Subsequently, the program branches to a program point 215.

At program point 215, second evaluation unit 50 estimates the new map section, starting from the present map section and the ascertained movement vectors. Subsequently, the program branches to a program point 220.

At program point 220, second evaluation unit 50 compares the estimated new map section with the new map section selected at program point 200, by difference formation. This means that second evaluation unit 50 subtracts the new map section estimated at program point 215 from the new map section selected at program point 215, whereby a difference image is created. Subsequently, the program branches to a program point 225.

At program point 225, second evaluation unit 50 generates the corresponding image data which include the difference image generated at program point 220, and causes second transmitting unit 55 to transmit the image data along with the difference image with the aid of a corresponding image signal from second send/receive antenna 75 via mobile radio network 85 to mobile terminal 5. The image signal is received, in this case, by first send/receive antenna 70, and is passed on via first receiving unit 30 to first evaluation unit 35. Subsequently, the program branches to a program point 230.

At program point 230, second evaluation unit 50 generates a data signal which includes the movement vectors ascertained for the individual blocks of the present map section, and causes second transmitting unit 55 to transmit this data signal from second send/receive antenna 75 via mobile radio network to mobile terminal 5. This data signal is then received by first send/receive antenna 70 and fed to first evaluation unit 35 via first receiving unit 30. Subsequently, the program branches to a program point 235. Program points 225 and 230 as in FIG. 3, in combination, here form program point 160 as in FIG. 2.

At program point 235, first evaluation unit 35 subdivides the present map section into the same image blocks as was done by second evaluation unit 50 at program point 205, and shifts the image blocks thus formed, in each case with the aid of the appertaining movement vector ascertained by second evaluation unit 50 and transmitted to mobile terminal 5. By the shifting of the image blocks formed, using the movement vectors, a shifted map section results. Subsequently, the program branches to a program point 240.

At program point 240, first evaluation unit 35 overlays the shifted map section with the received difference image. The summed image formed in this manner is subsequently brought to display on the display device of reproduction device 10, at a program point 245, caused by first evaluation unit 35, and essentially corresponds to the new map section, assuming error-free ascertainment and transmission of the difference image and the movement vectors from main station 1 to mobile terminal 5, which was ascertained at program point 200 by second evaluation unit 50. However, instead of the transmission of the entire new map section, only the transmission of the difference image and the movement vectors is required, so that bandwidth and time would be saved in this transmission, as compared to the transmission of the entire new map section. The program is subsequently exited. Program points 235, 240 and 245, as in FIG. 3, in combination here form program point 165 as in FIG. 2.

The method described as in FIG. 3 is also the one on which image compression methods H.261 and H.262 according to ITU-T Standard H.32x are based.

In the case of successive transmission of difference images and the appertaining movement vectors, on account of transmitting errors, an accumulation of errors may occur, which eventually corrupts the map section to be displayed on the display device of reproduction device 10, and, under certain circumstances, may lead to considerable deviations from the original map material. In order to avoid this, it may be provided that transmission and display of the new map section be carried out at specific times, e.g. at regular intervals, in exactly the same manner as for the very first map section according to program points 100, 105, 110 and 115. By such a so-called “image refresh”, the display on the display device of mobile terminal 5 is adjusted again and again to the original map material as stored in memory 45.

Of course, the position of mobile terminal 5, on which this map section is based, is faded into each new map section displayed on the display device of mobile terminal 5. In this context, the position is already faded into the difference image by second evaluation unit 50, so that the difference image is transmitted along with the faded-in position from main station 1 to mobile terminal 5.

A second specific embodiment for updating the map section to be displayed on the display device is shown with the aid of a flow diagram as in FIG. 4. Here, program point 155 as in FIG. 2 is subdivided into a program point 300 and a program point 305. At program point 300, second evaluation unit 50 ascertains the new map section based on the new position of mobile terminal 5, from the map material stored in memory 45 as described. The program subsequently branches back to program point 305.

At program point 305, second evaluation unit 50, by comparison of the new map section with the present map section, ascertains those map sections which are included only in the new map section, and not in the present map section. Subsequently, the program branches to a program point 310.

At program point 310, second evaluation unit 50 forms a data signal having image data which include the map regions ascertained at program point 305 and causes second transmitting unit 55 to transmit this image signal from second send/receive antenna 75 via mobile radio network 85 to mobile terminal 5. This image signal is received by first send/receive antenna 70 and fed to first evaluation unit 35 via first receiving unit 30. Subsequently, the program branches to a program point 315. The processes described at program point 310 according to FIG. 4 thus run as in program point 160 of FIG. 2.

At program point 315, first evaluation unit 35 computes an overall movement vector from the change in position of mobile terminal 5 from the previous position to the new position. Subsequently, the program branches to a program point 320.

At program point 320, first evaluation unit 35 shifts the map section displayed on the display device by the amount of the overall movement vector ascertained at program point 315, and fades in the position of mobile terminal 5 at the same location on the display device as for the present map section shown. On account of the shifting of the present map section by the amount of the overall movement vector, it may happen that individual map regions of the map section presently displayed get to lie outside the displayable range of the display device, and thus can no longer be displayed. On the other hand, on account of the shifting of the map section, empty spaces are created at another location in the displayable range of the display device, at which no map data can be displayed any longer. On account of the shifting of the presently displayed map section by the overall movement vector, the faded-in position of mobile terminal 5 remains the same at the display device. After program point 320, the program branches to a program point 325.

At program point 325, first evaluation unit 35 supplements the present map section shifted by the overall movement vector by the transmitted map sections at those locations at which there would otherwise be no display of map data on the display device. In this fashion, on the display device of mobile terminal 5, the result is a display of the new map section selected at program point 300, which is brought to display on the display device of reproduction device 10 in program point 330. Thus, program points 315, 320, 325 and 330 as in FIG. 4 form program point 165 as in FIG. 2. Subsequently, the program is exited.

The method described as in FIG. 4 has some advantages as compared to the method described with respect to FIG. 3:

1. No effortful computation of a difference image in second evaluation unit 50 takes place, but only the ascertainment of the supplementing map regions.

2. No movement vectors have to be transmitted from main station 1 to mobile terminal 5. Since the entire present map section is uniformly shifted in dependence upon the position change of mobile terminal 5, ascertainment of the overall movement vector is sufficient, so that no block-wise subdivision of the present map section and ascertainment of the appertaining movement vector are required.

3. An “image refresh” is not required, since with the supplementing map regions, parts of the original map material are transmitted in any case from main station 1 to mobile terminal 5.

Even if the subdivision of the present map section provided for the moved-image transmission, according to one current image compression method, and the allocation, in each case, of a movement vector to the individual image blocks, according to the method as in FIG. 4, are not necessary on account of the uniform shifting of the map section, one may still undertake a coding of these supplementing map regions according to a compression method as is customary in the transmission of moved images, for example, according to ITU-T Standard H.32.x, with the aid of an image compression method such as H.261 and H.263, for transmission of the supplementing map regions, ascertained according to the method as in FIG. 4, from main station 1 to mobile terminal 5.

For the transmission of the image data from main station 1 to mobile terminal 5, in all the cases described, a video channel according to the H.323 Standard may be arranged from main station 1 to mobile terminal 5. To be sure, the image data may also be transmitted coded, according to any compression method, from main station 1 to mobile terminal 5.

If sufficient transmission bandwidth is available for transmitting image data from main station 1 to mobile terminal 5 via mobile radio network 85, according to a third specific embodiment it may also be provided that each new map section shall be transmitted in its entirety from main station 1 to mobile terminal 5 and shall there be displayed on the display device. For this then, program points 100, 105, 110 and 115 as in FIG. 2 are successively run through, and if a navigational application is desired, after each newly ascertained position of mobile terminal 5, a new route to the input destination being able to be carried out according to program points 130, 135 and 140. If the user of mobile terminal 5 enters any position in input device 20, he can request the appertaining map section from main station 1, in the manner described. A new position can then occur, for example, by using so-called directional keys or arrow keys on input device 20, which each specify an overall movement vector of a definite length. In this manner, the map section displayed on the display device of mobile terminal 5 may be shifted by the user in any direction and be supplemented by new map regions corresponding to any one of the three described specific embodiments.

The assumption for the display of map material on mobile terminal 5 is a sufficiently large display device. In this context, data concerning the size of the display device of mobile terminal 5 may be transmitted, as described, before the transmission of the first map section to main station 1 or to second evaluation unit 50. In general, mobile terminal 5 may transmit control data to main station 1 or second evaluation unit 50, before the first transmission of a map section, which include data concerning the display capabilities and display possibilities of mobile terminal 5, which, besides the size of the display device, may also contain the resolution properties and statements concerning the color capability of the display device, or the like. However, it may also be provided to supply the statements on the capabilities of the display device of mobile terminal 5 to main station 1 from a central databank, in which pertinent data on several mobile terminals may be stored. The display device may be integrated into mobile terminal 5, may be capable of being plugged onto it, or may be connected to it by a cable connection or in a wireless manner.

In the case of the second specific application described as in FIG. 4, the image data to be transmitted from main station 1 to mobile terminal 5 may optionally be compressed. In this connection, compression can be carried out using an image compression method for moved image transmission, for instance, according to ITU-T Standard H.32x and one of image compression methods H.261 and H.263 used in this standard. On account of the static nature of the image data to be transmitted, which are based on geographical map material and thus include fixed images, a compression of the image data to be transmitted that is more efficient for this application can also be used, than what is required for the transmission of moved images. In this context, for instance, a so-called run length coding or a compression method adapted especially to the statistics of the map data may be used.

The methods described in connection with the first and above all the second specific embodiment make possible in current mobile networks, for example, according to the GSM Standard (Global System for Mobile Communications) or the DCS 1800 Standard (Digital Communication System), even at a data rate of only 9.6 kbit/s, a position tracing of mobile terminal 5 in a map section that is current in each case, as described. New mobile networks of the third generation, for example, according to the UMTS Standard (Universal Mobile Telecommunication System) or according to the GPRS Standard (General Packet Radio Service) will offer data rates up to 2 Mbit/s in the future. This permits the genuine transmission of moved images and offers an optimal prerequisite and thus an improved quality of navigational services such as, for example, the display of a virtual world. At data rates up to 2 Mbit/s, complete transmission of the map section, completely up to date in each case, from main station 1 to mobile terminal 5 according to the third specific embodiment is possible without problem.

As to mobile terminal 5, this may be any mobile telecommunication terminal.

Accounting for the services used by terminal 5 for transmitting map section data and possibly route proposals may be done via the telephone bill. One or more successive telecommunication connections may be used, for transmitting the location-related data information between main station 1 and mobile terminal 5, which are based in each case on calling the appropriate call number of main station 1 or mobile terminal 5.

1. A method for transmitting Location-related data information between a main station (1) and a mobile terminal (5), especially a mobile telecommunications terminal, in a first step, a position of a mobile terminal (5) being ascertained and transmitted to the main station (1); in a second step, location-related data information for the mobile terminal (5) being formed in the main station (1) in dependence upon the ascertained position of the mobile terminal (5); in a third step, the location-related data information being transmitted from the main station (1) to the mobile terminal (5); and in a fourth step, the location-related data information received being brought to reproduction on a reproduction device (10) of the mobile terminal (5), wherein in the first step, information on the size of the map section reproducible on the reproduction device (10) is transmitted from the mobile terminal (5) to the main station (1).

2. The method as recited in claim 1,
wherein in the second step, a section of a geographical map is selected in the main station (1) which includes the ascertained position of the mobile terminal (5); in the third step, the selected map section is transmitted from the main station (1) to the mobile terminal (5); and in the fourth step, the transmitted map section having the ascertained position is brought to reproduction on a reproduction device (10) of the mobile terminal (5).

3. The method according to claim 1 or 2,
wherein in the second step, a route proposal between the ascertained position of the mobile terminal (5) and a specified destination is computed in the main station (1); the route proposal is transmitted in the third step from the main station (1) to the mobile terminal (5); and the route proposal is reproduced in the fourth step on the reproduction device (10) of the mobile terminal (5).

4. The method as recited in claim 3,
wherein the destination is input on the mobile terminal (5) in the first step, and is transmitted to the main terminal (1).

5. The method as recited in claim 3 or 4,
wherein the selected map section is transmitted to the mobile terminal (5) in coded form by a compression method, particularly by using one of image compression methods H.261 and H.263 according to ITU-T Standard H.32x (International Telecommunication Union).

6. The method as recited in one of claims 2 through 5,
wherein in a second step, the map section is selected in such a way that the position of the mobile terminal (5) ascertained in the first step lies essentially in a middle region of the selected map section.

7. The method as recited in one of claims 2 through 6,
wherein in a fifth step, a new position of the mobile terminal (5) is ascertained and transmitted to the main station (1); in a sixth step, a new map section is selected in the main station (1), which includes the new position of the mobile terminal; in a seventh step, image data are transmitted from the main station (1) to the mobile terminal (5), in dependence upon differences between the selected new map section and the present map section; and in an eighth step, the present map section is brought updated to reproduction on the reproduction device (10) of the mobile terminal (5), in dependence upon the transmitted image data.

8. The method as recited in claim 7,
wherein in a sixth step, the new map section is selected in such a way that the new position of the mobile terminal (5) ascertained in the fifth step lies essentially in a middle region of the selected new map section.

9. The method as recited in claim 7 or 8,
wherein at the selection of the new map section in the sixth step, especially when using one of image compression methods H.261 and H.263, the present map section is subdivided into individual image blocks; a movement vector is computed for each of the image blocks in dependence upon the change in position from the previous position to the new position of the mobile terminal (5); the new map section is estimated starting from the present map section and the movement vectors; the estimated map section is compared to the new map section by difference formation, so that a difference image is created; using the image data in the seventh step, the difference image is transmitted to the mobile terminal (5); in the seventh step, the movement vectors are also transmitted from the main station (1) to the mobile terminal (5); and in the eighth step, the map section to be reproduced on the reproduction device (10) is computed from the present map section, in that the present map section is shifted block-wise with the aid of the movement vectors, and the shifted map section formed in this way is overlaid with the difference image.

10. The method as recited in claim 9,
wherein at specified times in the seventh step, the new map section is transmitted from the main station (1) to the mobile terminal (5) with the aid of the image data, and in the eighth step, the new map section having the new position is brought to reproduction on the reproduction device (10).

11. The method as recited in claim 7 or 8,
wherein during selection of the new map section in the sixth step, map regions are ascertained which are included only in the new map section and not in the present map section; in the seventh step, the ascertained map regions are transmitted from the main station (1) to the mobile terminal (5) with the aid of the image data; and in the eighth step, the map section to be reproduced on the reproduction device (10) is computed from the presently reproduced map section, in that the present reproduced map section is shifted with the aid of the overall movement vector computed based on the position change of the previous position to the new position of the mobile terminal (5), and the shifted map section formed in this manner is supplemented by the transmitted map sections.

12. The method as recited in one of claims 7 through 11,
wherein the image data are transmitted to the mobile terminal (5) coded by a compression method, particularly by using one of image compression methods H.261 and H.263 according to ITU-T Standard H.32x.

13. The method as recited in one of claims 2 through 12,
wherein the position of the mobile terminal (5) is ascertained by a position-finding receiver (15), especially a GPS receiver (Global Positioning System).

14. The method as recited in one of claims 2 through 13,
wherein the position of the mobile terminal (5) is input on an input device (20) of the mobile terminal (5).

15. A mobile terminal (5), especially a mobile telecommunications terminal (5), for carrying out a method as recited in one of the preceding claims, an evaluation unit (35) being provided which ascertains a new position of the mobile terminal (5); a transmitting unit (25) being provided which transmits the ascertained position to a main station (1); a receiving unit (30) being provided which receives location-related data information, generated in dependence on the ascertained position, from the main station (1); and a reproduction device (10) being provided on which a reproduction of the location-related data information is carried out,
wherein the transmitting unit (25) transmits information to the main station (1) on the size of the map section reproducible on the reproduction device (10).

16. The mobile terminal (5) as recited in claim 15,
wherein the location-related data information is developed as a section of a geographical map and/or as a route proposal.

17. The mobile terminal (5) as recited in claim 15 or 16,
wherein the transmitting unit (25) transmits a new position ascertained by the evaluation unit (35) to the main station (1); and the evaluation unit (35) updates a map section presently reproduced on the reproduction device (10) in dependence upon the image data received from main station (1) after the transmission of the new position.

18. The mobile terminal (5) as recited in claim 17,
wherein the receiving unit (30), by use of the image data, receives a difference image between a new map section and an estimated new map section from the main station (1); the receiving unit (30) also receives movement vectors from the main station (1) which are allocated to individual blocks of the present map section; the evaluation unit (35) computes the map section to be reproduced on the reproduction device (10) from the present map section, in that the present map section is shifted block-wise with the aid of the movement vectors, and the shifted map section formed in this way is overlaid with the difference image.

19. The mobile terminal (5) as recited in claim 17,
wherein the receiving unit (30) receives map sections from the main station (1) with the aid of the image data; the evaluation unit (35) computes the map section to be reproduced on the reproduction device (10) from the presently reproduced map section, in that it ascertains an overall movement vector from the position change of the previous position to the new position of the mobile terminal (5), it shifts the presently reproduced map section with the aid of the computed overall movement vector and it supplements the shifted map section formed in this manner by the transmitted map sections.

20. The mobile terminal (5) as recited in one of claims 15 through 19,
wherein a location finding receiver (15), especially a GPS receiver, is provided which receives location finding data for position ascertainment.

21. The mobile terminal (5) as recited in one of claims 15 through 20,
wherein an input device (20) is provided on which the position of the mobile terminal (5) may be input.

22. A main station (1) for executing the method as recited in one of claims 1 through 14, a receiving unit (40) being provided which receives data about a position of a mobile terminal (5), especially a mobile telecommunications device; an evaluation unit (50) being provided which forms location-related data information in dependence upon the position of the mobile terminal (5); and a transmitting unit (55) being provided which transmits the location-related data information to the mobile terminal (5).
wherein the receiving unit (40) receives information on the size of the map section reproducible on the reproduction device (10) of the mobile terminal (5); and the evaluation unit (50) selects the map section in such a way that it is completely reproducible on the reproduction device (10) of the mobile terminal (5).

23. The main station (1) as recited in claim 22,
wherein a memory (45) is provided in which geographical map material is stored; the evaluation unit (50) selects a map section from the memory (45) which includes the position of the mobile terminal (5); and the selected map section at least partially forms the location-related data information.

24. The main station (1) as recited in claim 22 or 23,
wherein the evaluation unit (50) computes a route proposal from the position of the mobile terminal (5) and an input destination received from the mobile terminal (5); and the route proposal at least partially forms the location-related data information.

25. The main station (1) as recited in claim 23 or 24,
wherein the evaluation unit (50), upon receiving a new position of the mobile terminal (5) by the receiving unit (40), selects a new map section which includes the new position of the mobile terminal (5); and the evaluation unit (50) transmits image data via the transmitting unit (55) to the mobile terminal (5), in dependence upon differences between the selected new map section and the present map section.

26. The main station (1) as recited in claim 25,
wherein the evaluation unit (50) subdivides the present map section into individual image blocks; the evaluation unit (50) computes a movement vector for each of the image blocks in dependence upon the change in position from the previous position to the new position of the mobile terminal (5); the evaluation unit (50) estimates the new map section starting from the present map section and the movement vectors; the evaluation unit (50) compares the estimated map section to the new map section by difference formation, so that a difference image is created; the transmitting unit (55) transmits the difference image to the mobile terminal (5) with the aid of the image data; and the transmitting unit (55) also transmits the movement vectors to the mobile terminal (5).

27. The main station (1) as recited in claim 25,
wherein the evaluation unit (50), during selection of the new map section, ascertains map regions which are included only in the new map section and not in the present map section; and the transmitting unit (55) transmits the ascertained map regions to the mobile terminal (5) with the aid of the image data.
